(19) United States
(12) Patent Application Publication
(10) Pub. No.: US 2008/0312791 A1
(43) Pub. Date: Dec. 18, 2008

(54) Apparatus and Method for Application of Force to a Steering Device

(76) Inventors: Werner Knee, Esslingen (DE); Jens Schick, Herrenberg (DE); Alexander Wuerz-Wessel, Stuttgart (DE); Stefan Sickert, Ludwigsburg (DE)

Correspondence Address: KENYON & KENYON LLP, ONE BROADWAY, NEW YORK, NY, 10004, US

(21) Appl. No.: 11/792,897

(22) PCT Filed: Dec. 13, 2005
(86) PCT No.: PCT/EP05/56755

§ 371 Date: Apr. 4, 2008

(30) Foreign Application Priority Data
Dec. 27, 2004 (DE) 10 2004 062 818.1

(51) Int. Cl. B62D 5/04; B62D 6/00

(52) U.S. Cl. 701/41; 180/443

(57) ABSTRACT

An apparatus for application of force to a steering device, e.g., of a motor vehicle, includes an operative apparatus associated with the steering device and a counterelement disposed on the steering device. The operative apparatus has an induction assemblage producing an electromagnetic force on the counterelement, and the counterelement has at least one electromagnetically influenceable region, so that a force displacing the counterelement with respect to the operative apparatus can be produced for application of force to the steering device.

### BACKGROUND OF THE INVENTION

1. Field of the Invention

The present invention relates to a method and an apparatus for application of force to a steering device, e.g., of a motor vehicle.

2. Description of Related Art

Apparatuses for application of force to a steering device, in particular to the steering device of a motor vehicle, are known. They are used in particular in conjunction with driver assistance systems that serve to guide a motor vehicle on a defined roadway lane. The lane is surveyed using sensor systems. Based on the results obtained it is then possible, for example to detect a departure from the lane or to extrapolate a point in time at which the motor vehicle would depart from the lane without further intervention. From the data obtained, possibilities can be derived for assisting the driver with notifications or even by way of an active intervention. Notifications are given according to the existing art, for example, via a loudspeaker or by way of a vibration of the seating surface on the driver's side. These methods do warn the driver, but do not indicate sufficiently quickly to him/her which actions are to be initiated in order to avert the potentially hazardous situation. For example, to a driver who has momentarily fallen asleep and has driven beyond a delimiting line, it is not clear at the moment of the warning notification how vigorously and in which direction a steering motion returning the motor vehicle to the lane must be effected. To eliminate this disadvantage, actuating motors can be used that are mechanically connected to a steering column of the steering device. When the sensors recognize, for example, that the vehicle is departing from the lane to the right, a force or torque is then exerted by way of the motor on the steering column, in order to modify the steering angle to the left and return the vehicle to the lane. It is disadvantageous in this context, however, that faults in the motor or in the motor control system can apply an undesired erroneous torque to the steering column, which can cause transverse dynamics to be endangered. The motor additionally constitutes, with its own rotational inertia (especially in the case of a large conversion ratio), a disruptive change in steering feel, which is unacceptable to the vehicle driver. The desire therefore still exists for an apparatus that influences steering feel only insignificantly or not at all, and does not represent a risk in the event of malfunction.

### BRIEF SUMMARY OF THE INVENTION

For an apparatus for application of force to a steering device, in particular of a motor vehicle, having an operative apparatus associated with the steering device and a counterelement disposed on the steering device or belonging to it, it is provided according to the present invention that the operative apparatus have an induction assemblage producing an electromagnetic force on the counterelement, the counterelement having at least one electromagnetically influenceable region, so that a force displacing the counterelement with respect to the operative apparatus can be produced for application of force to the steering device. The operative apparatus is disposed on a part (or parts) of the motor vehicle that is/are stationary with respect to the movable parts of the steering device, while the counterelement is disposed on the steering device in such a way that a spatial displacement of the counterelement, whether a displacement along a straight line or curve or a rotation about an axis, produces an application of force to the steering device. In particular, a rigid connection between the counterelement and the steering device can be selected. When the operative apparatus is switched to an inactive state, i.e., it is not exerting electromagnetic force on the counterelement, the counterelement is decoupled from the operative apparatus. This means that when manually actuating the steering device by way of an operating element, ordinarily a steering wheel, the vehicle driver does not perceive the presence of the apparatus. The steering feel thus remains entirely, or at least substantially, unmodified. When a situation occurs in which a central monitoring device of the motor vehicle ascertains the need for an assisting intervention in the steering device, the operative apparatus is then switched to an active state, i.e., it exerts an electromagnetic force on the counterelement. Because the operative apparatus is substantially stationary with respect to the vehicle, a force occurs which acts to displace the counterelement relative to the operative apparatus and thereby to actuate the steering device. Because of certain tolerances within the steering device, and further forces and moments that act on the steering device, this application of force to the steering device need not necessarily result in a modification of the steering angle, even though with an appropriate design of the apparatus and the control system of the operative apparatus, an electromagnetic force can be produced that is sufficient for a modification of the steering angle. The operative apparatus can also be switched between different control states so that over time, applications of force having different magnitudes and/or in different directions are produced. It is thereby possible to trigger an alternating displacement of the steering device or in parts thereof, in particular in the form of a vibration, oscillation, shuddering, or shaking, which is perceptible by the vehicle driver in particular by the fact that he/she feels or detects this alternating displacement through his/her hand on the steering wheel. The latter signaling variant has the additional advantage that the warning function proceeding from the apparatus remains substantially unnoticed by other vehicle occupants, so that in situations in which the vehicle driver, for example, deliberately departs from the lane or deliberately drives beyond a line, the warning signal does not bring about an unnecessary feeling of insecurity in the vehicle occupants. Be it noted that the alternating displacement can also be combined with a targeted application to modify the steering angle. As a result, the driver is informed of a possibly hazardous situation, and at the same time the change in steering angle necessary to reduce or avert the hazard is effected. The counterelement can be configured in numerous ways, as long as the electromagnetic force generated by the operative apparatus results in the application of force to the steering device. If the steering device already possesses a region (or several regions) that is/are electromagnetically influenceable, an additional counterelement can then be omitted, since the counterelement for purposes for the invention is already implemented in the steering device, i.e., belongs to the steering device.

Advantageously, the operative apparatus is associated with a steering column of the steering device, and the counterelement is disposed on the steering column or belongs to it. A particularly favorable disposition of the apparatus results therefrom. For example, the operative apparatus can be integrated into an existing switch module. An application of force then acts as a torque on the steering column.

In an example embodiment of the present invention, electricity is fed to the induction assemblage from an energy reservoir, in particular from a capacitor having a capacitance matched to a maximally desired effect of the apparatus. It is thereby possible to ensure that even in the event of a fault, the apparatus can produce only a limited application of force to the steering device. Provision can be made in particular for a maximum duration from one second to five seconds, e.g., approximately three seconds, and/or a maximum change in steering angle of 10 to 50 degrees, e.g., 30 degrees.

The apparatus advantageously has a charge checking device that monitors the charge status of the energy reservoir. It is possible on the one hand to monitor whether the charge status is sufficient for the functionality of the apparatus, and on the other hand whether the maximum stipulated voltage level of the energy reservoir is being maintained. If a deviation from the target state is ascertained, notifications as to a malfunction can be issued and/or a shutdown of the apparatus can be performed.

According to an example embodiment of the invention, the induction assemblage has multiple induction elements, e.g., embodied as coils. This allows a multitude of patterns of force application to be caused to act on the counterelement, especially in the context of a time-offset switching of the induction elements.

It is advantageous if the induction elements are disposed along a circular arc substantially concentric with the steering column. This results in a particularly compact assemblage along with high efficiency.

The invention furthermore relates to a method for application of force to a steering device, in which method a counterelement disposed on the steering device and having at least one electromagnetically influenceable region is displaced by an operative apparatus generating an electromagnetic force.

Advantageously, the counterelement carries out a rotational displacement as a result of the application of force. If the counterelement is disposed on a steering column of the steering device, the counterelement can then be displaced, in particular, on a circular path about the central axis of the steering column. A particularly suitable interaction with the operative apparatus results if the induction elements are disposed along a second circular track about the central axis of the steering column, and radially spaced at least slightly away from the counterelement. The term “rotational displacement” is to be understood as a motion, even a very small one, of the counterelement on an at least approximately circular track.

In an example embodiment of the invention, the rotational displacement is accomplished in alternating directions. This allows the vibration, oscillation, shuddering, or shaking explained above to be implemented in simple fashion.

Advantageously, at least one induction element associated with the operative apparatus, e.g., a coil, is controlled by an open- or closed-loop control unit using a control signal that is variable over time. A multitude of patterns of application of force onto the counterelement can thereby be implemented. In particular, a continuous application of the force in the same direction, similar to the operative principle of an electrical machine, and/or the above-described alternating displacement, can be produced by way of an appropriate energization, usually of multiple induction elements. If multiple induction elements are used, which will usually be the case, each can then be controlled via a separate control signal, or control can be applied to multiple induction elements in groups.

It is advantageous if at least one profile of the control signal is stored. It is thus possible to determine or calculate desired profiles in advance, so that upon activation of the operative apparatus, the stored profile merely needs to be retrieved.

According to an example implementation of the method, at least one profile of the control signal is configured in such a way that a sequence of multiple applications of force, brought about by way of the control signal, results in a substantially unmodified steering angle of the steering device. The driver can in this fashion be informed of a possibly hazardous situation even though an effective intervention in the steering device, in particular with regard to the steering angle, is not accomplished.

Advantageously, at least one profile of the control signal is configured in such a way that a sequence of multiple applications of force, brought about by way of the control signal, results in a modified steering angle of the steering device. A correction or precorrection of the steering angle can thereby be effected in order to move the vehicle back toward the desired vehicle state. In addition, the effective torque that influences the steering device can inform the driver, who is grasping the steering wheel operatively connected to the steering device, as to the direction in which the steering angle is to be corrected. For example, if the vehicle is on the verge of driving beyond the right-hand driving lane boundary, the driver can then be informed, by way of a torque that acts inter alia on the steering wheel as a counterclockwise torque, that he or she must drive farther to the left.

Advantageously, a steering angle expected on the basis of the application of force to the steering device is compared with an actual steering angle. Unexpected operating conditions can thereby be detected, and countermeasures can be initiated as required.

The operative apparatus is switched into an inactive state if the magnitude of the difference between the expected and actual steering angle exceeds a specific threshold value. A situation can occur in which the central monitoring device of the motor vehicle ascertains the need for a correction of the steering angle and activates the apparatus, but the driver deliberately wishes to maintain the existing vehicle situation, e.g. the driver has deliberately driven beyond the lane boundary. In this situation the driver grasps the steering wheel so that he or she opposes, with a force, the application of force to the steering device by the apparatus. The defined application of force will thus not result in the steering angle that might have been expected. Because the operation of the apparatus must remain subordinate to the driver's intentions, the operative apparatus will be switched into an inactive state in the aforementioned case.

It is additionally advantageous that a charge checking device monitors the charge status of an energy reservoir associated with the operative apparatus, and upon detection of a malfunction switches off the operative apparatus and/or empties the energy reservoir. If the charge status of the energy reservoir should be outside a target range, in particular above it, the operative apparatus will be switched into an inactive state. In the event of an excessive voltage of the energy reservoir, the operative apparatus might otherwise cause an excessively large application of force.

### BRIEF DESCRIPTION OF THE SEVERAL VIEWS OF THE DRAWING

FIG. 1 shows an apparatus according to the present invention for application of force to a steering device.

### DETAILED DESCRIPTION OF THE INVENTION

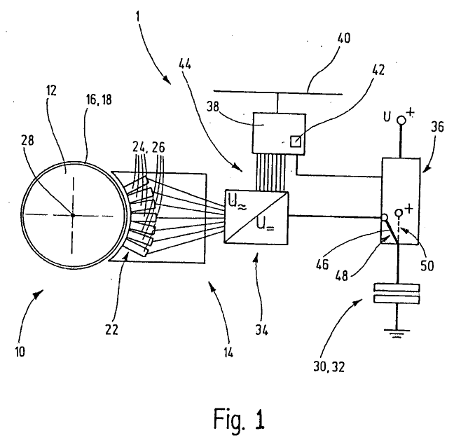

The FIG. 1 shows an apparatus 1 for application of force to a steering device 10, here via a steering column 12, having an operative apparatus 14 associated with steering device 10 and a counterelement 16 disposed on steering device 10. Counterelement 16 has at least one electromagnetically influenceable region 18 that is embodied in accordance with the manner of operation described in general above. Operative apparatus 14 exerts, with an induction assemblage 22 constituted here from multiple induction elements 24 or coils 26, an electromagnetic force on counterelement 16 when appropriately triggered, and thereby exerts a torque on steering column 12 about central axis 28 of steering column 12. Induction elements 24 are disposed along a circular arc substantially concentric with steering column 12 and spaced away from counterelement 16. Electricity is fed to induction assemblage 22 from an energy reservoir 30, embodied here as a capacitor 32, via a converter apparatus 34. Capacitor 32 is charged by way of a charging unit 36 that is connected to a voltage U. An open-loop control unit 38, optionally also embodied as a closed-loop control unit, evaluates signals from an information transfer system 40, monitors the charge status of capacitor 32 and the operation of charging unit 36 by way of an integrated charge checking device 42, and controls converter apparatus 34 as necessary via control lines 44.

Charging unit 36 has a switch 46 that can be switched between a first position 48 depicted with a solid line and a second position 50 depicted with a dashed line. In first position 48, an electrical connection exists between capacitor 32 and converter apparatus 34, capacitor 32 and converter apparatus 34 being decoupled from voltage U. (The voltage supply is again symbolically depicted here in charging unit 36 in order to illustrate the operating principle.) In contrast thereto, in second position 50 an electrical connection exists between capacitor 32 and the voltage supply, converter apparatus 34 being decoupled both from the voltage supply and from capacitor 32. This means that converter apparatus 34 can always be powered only from capacitor 32 having a limited capacitance, and an uncontrolled connection to the voltage supply (voltage U), which represents, as it were, an almost unlimited energy source, is precluded. The manner of operation of apparatus 1 will be described below.

Initially, the charging operation of capacitor 32 via charging unit 36 is triggered by an external signal, switch 46 being in second position 50. The charging operation ends when a predetermined target voltage is reached, and switch 46 is moved into first position 48. Apparatus 1 is now ready to operate. When control unit 38 receives from information transfer system 40 a signal that requests activity by apparatus 1, control unit 38 controls converter apparatus 34 via control lines 44. In this instance, the triggering occurs on the basis of profiles or signal sequences stored in control unit 38. Control unit 38 can react to different situations with a variety of signal sequences. The operation of a converter apparatus 34 is known per se, and will not be explained further. In the exemplary embodiment shown, an alternating voltage (in this case a three-phase current U.) is generated from a DC voltage U. by way of suitable circuit assemblages in converter apparatus 34. A shaking motion, which optionally creates a resulting residual torque for steering-angle correction, is thereby produced at steering column 12. Only a targeted triggering of coils 26 results in such a residual torque, so that, for example in malfunctions involving a random triggering or a persistence of the signal sequences at a fixed level, a continuous residual torque does not occur.

In summary, the present invention is notable in particular for the following advantages:
When apparatus 1 is deactivated, the result is a steering feel that is unchanged as compared with a steering apparatus 10 without an apparatus 1.
Because operative apparatus 14 is powered indirectly, the maximum possible application of force is kept within defined limits.
Because converter apparatus 34 is at no time connected directly to voltage U, voltage U can never cause a direct energization of coils 26.
The charge checking system ensures that energy reservoir 30 is charged only to a defined level.
An effective application of force to steering device 10 is accomplished only in a context of specific energization patterns of coils 26. A random or time-invariant energization does not result in a continuous application of force.

Apparatus 1 is therefore very safe, and remains unnoticed when inactive.

1-16. (canceled)

17. An apparatus for application of force to a steering device of a motor vehicle, comprising:
an operative element associated with the steering device; and
a counterelement disposed on the steering device;
wherein the operative element has an induction assemblage producing an electromagnetic force on the counterelement, and wherein the counterelement has at least one electromagnetically influenceable region, whereby a force displacing the counterelement with respect to the operative element is produced for application of force to the steering device.

18. The apparatus as recited in claim 17, wherein the operative element is associated with a steering column of the steering device, and wherein the counterelement is disposed on the steering column.

19. The apparatus as recited in claim 18, wherein electricity is supplied to the induction assemblage from an energy reservoir configured as a capacitor having a capacitance matched to a selected maximally desired effect of the apparatus.

20. The apparatus as recited in claim 19, further comprising:
a charge monitoring device configured to monitor the charge^{•} status of the energy reservoir.

21. The apparatus as recited in claim 19, wherein the induction assemblage has multiple induction elements configured as coils.

22. The apparatus as recited in claim 21, wherein the induction elements are disposed along a circular arc substantially concentric with the steering column.

23. A method for application of force to a steering device, comprising:
providing an operative element associated with the steering device, wherein the operative element has an induction assemblage producing an electromagnetic force;
providing a counterelement disposed on the steering device, wherein the counterelement has at least one electromagnetically influenceable region; and
displacing the counterelement by the electromagnetic force generated by the operative element, whereby force is applied to the steering device.

24. The method as recited in claim 23, wherein the displacement of the counterelement is a rotational displacement.

25. The method as recited in claim 24, wherein the rotational displacement is achieved in alternating directions.

26. The method as recited in claim 24, wherein the induction assemblage includes at least one induction element configured as a coil, and wherein the at least one induction element is controlled by one of an open-loop and a closed-loop control implemented by a control unit using a control signal that is variable over time.

27. The method as recited in claim 26, wherein at least one profile of the control signal is stored.

28. The method as recited in claim 26, wherein at least one profile of the control signal is configured in such a way that a sequence of multiple applications of force is achieved based on the control signal, and wherein the sequence of multiple: applications of force results in a substantially unmodified steering angle of the steering device.

29. The method as recited in claim 26, wherein at least one profile of the control signal is configured in such a way that a sequence of multiple applications of force is achieved based on the control signal, and wherein the sequence of multiple applications of force results in a modified steering angle of the steering device.

30. The method as recited in claim 29, further comprising:
calculating a steering angle to be achieved based on the application of force to the steering device; and
comparing the calculated steering angle with an actually achieved steering angle.

31. The method as recited in claim 29, wherein the operative element is switched into an inactive state if the magnitude of the difference between the calculated steering angle and the actually achieved steering angle exceeds a predetermined threshold value.

32. The method as recited in claim 26, further comprising:
monitoring, by a charge monitoring device, the charge status of an energy reservoir supplying energy to the operative element; and
one of switching off the operative element and draining the energy reservoir upon detection of a malfunction of the energy reservoir.
